(19) United States
(12) Patent Application Publication
(10) Pub. No.: US 2022/0300457 A1
(43) Pub. Date: Sep. 22, 2022

(54) INFORMATION PROCESSING APPARATUS AND NON-TRANSITORY COMPUTER READABLE MEDIUM STORING INFORMATION PROCESSING PROGRAM

(71) Applicant: FUJIFILM Business Innovation Corp., Tokyo (JP)

(72) Inventor: Yohei UCHIUMI, Kanagawa (JP)

(73) Assignee: FUJIFILM Business Innovation Corp., Tokyo (JP)

(21) Appl. No.: 17/404,979

(22) Filed: Aug. 17, 2021

(30) Foreign Application Priority Data
Mar. 17, 2021 (JP) 2021-043746

(51) Int. Cl. G06F 16/174; G06F 40/169; G06F 16/34; G06F 16/38

(52) U.S. Cl. CPC G06F 16/174; G06F 40/169; G06F 16/34; G06F 16/38

(57) ABSTRACT

An information processing apparatus includes a processor configured to receive original data that is created by a data creator and has additional information, from a data transmitter, and in a case where a request for the original data from a data utilizer who is a utilizer other than a data manager who is at least one of the data creator or the data transmitter is made, provide additional information-removed data that is obtained based on the original data and in which the additional information is removed, to the data utilizer.

### CROSS-REFERENCE TO RELATED APPLICATIONS

This application is based on and claims priority under 35 USC 119 from Japanese Patent Application No. 2021-043746 filed Mar. 17, 2021.

### BACKGROUND

### (i) Technical Field

The present invention relates to an information processing apparatus and a non-transitory computer readable medium storing an information processing program.

### (ii) Related Art

JP6002256B discloses an annotation control method of displaying different annotations for each utilizer who uses an annotation, by attaching conditional information for designating the annotation to be displayed/not displayed to the annotation.

### SUMMARY

In the related art, an information processing apparatus that, in a case where a request from a utilizer is made, provides data corresponding to the request to the utilizer is known. Accordingly, a plurality of utilizers can download and use data from the information processing apparatus.

The data that may be provided to the plurality of utilizers may have additional information. For example, the additional information includes note information (data that can be visually recognized together with a content of the data by a user who opens the data; for example, an annotation such as a tag attached to an electronic document) or attribute information (meta information about the data).

Here, a data creator who creates the data, or a data transmitter (hereinafter, at least one of the data creator or the data transmitter will be referred to as a data manager; the data creator and the data transmitter may be an identical person) who stores the data in the information processing apparatus may not want the additional information added to the data to be viewed by a data utilizer who is a utilizer other than the data manager. For example, confidential information may be included in the additional information.

The data manager is considered to set the additional information that is not wanted to be viewed by the data utilizer, to be not displayed to the data utilizer. However, in a case of setting the additional information to be not displayed, the data utilizer may view the additional information due to a setting error or the like. Accordingly, for example, the additional information is not to be added to (in other words, to be removed from) data provided to the data utilizer.

In order not to allow the data utilizer to view the additional information added to the data while enabling the plurality of utilizers to use the data, the data manager is considered to prepare original data having the additional information and data obtained by removing the additional information from a duplicate of the original data and store the two pieces of data in the information processing apparatus. In this case, the information processing apparatus provides duplicated data in which the additional information is removed to the data utilizer, and provides the original data having the additional information to the data manager. However, in this case, a problem arises in that the data manager has to make an effort of preparing and storing the two pieces of data in the information processing apparatus.

Aspects of non-limiting embodiments of the present disclosure relate to an information processing apparatus and a non-transitory computer readable medium storing an information processing program that reduce an effort of a data manager for not allowing a data utilizer to view additional information added to data while enabling a plurality of utilizers to use the data, compared to a case where the data manager prepares and stores original data and data in which the additional information is removed from the original data in the information processing apparatus.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to receive original data that is created by a data creator and has additional information, from a data transmitter, and in a case where a request for the original data from a data utilizer who is a utilizer other than a data manager who is at least one of the data creator or the data transmitter is made, provide additional information-removed data that is obtained based on the original data and in which the additional information is removed, to the data utilizer.

### BRIEF DESCRIPTION OF THE DRAWINGS

Exemplary embodiment(s) of the present invention will be described in detail based on the following figures, wherein:

FIG. 1 is a schematic configuration diagram of an information processing system according to an exemplary embodiment;

FIG. 2 is a schematic configuration diagram of a manager terminal;

FIG. 3 is a schematic configuration diagram of a utilizer terminal;

FIG. 4 is a schematic configuration diagram of a server;

FIG. 5 is a diagram illustrating a display example of an original document that has additional information;

FIG. 6 is a conceptual diagram illustrating processing contents of a removed document generation unit and a document provision unit;

FIG. 7 is a diagram illustrating a first display example of an additional information-removed document;

FIG. 8 is a diagram illustrating a first example of an editing screen of the original document;

FIG. 9 is a diagram illustrating a second example of the editing screen of the original document;

FIG. 10 is a diagram illustrating a second display example of the additional information-removed document; and

FIG. 11 is a flowchart illustrating a flow of processing of the server.

### DETAILED DESCRIPTION

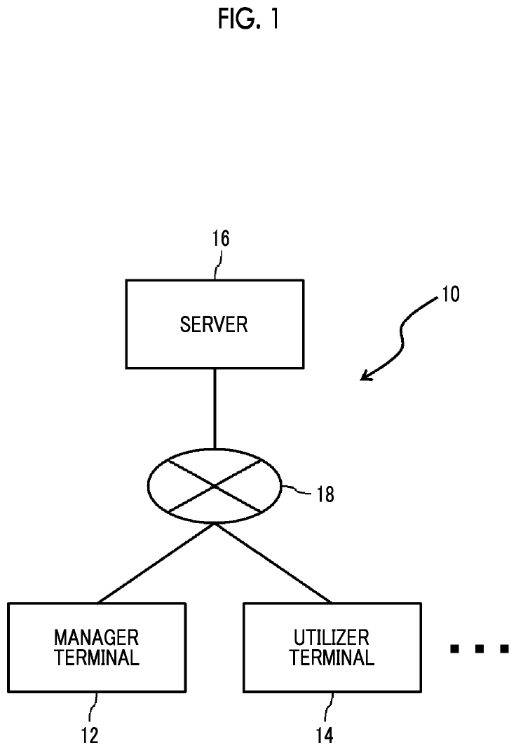

FIG. 1 is a schematic configuration diagram of an information processing system 10 according to the exemplary embodiment. The information processing system 10 according to the exemplary embodiment is configured to include a manager terminal 12 that is used by a data manager, a utilizer terminal 14 that is used by a data utilizer, and a server 16 as an information processing apparatus. The manager terminal 12, the utilizer terminal 14, and the server 16 are communicably connected to each other through a communication line 18 including, for example, an Internet line and a local area network (LAN).

The server 16 authenticates a user as a utilizer and then, provides a data management service to the user. That is, the server 16 is said to be a data management server, and the information processing system 10 is said to be a data management system. The data management service is a service for managing data received from the user and, in a case where a request for data is made from the user, providing the data to the user. Here, a user who creates data will be referred to as a data creator, and a user who transmits data to the server 16 will be referred to as a data transmitter. In the exemplary embodiment, the data creator and the data transmitter are an identical person. However, the data creator and the data transmitter may be different persons. The data manager means at least one of the data creator or the data transmitter. In addition, the data utilizer means a user other than the data manager. In addition, the user is a concept including the data creator, the data transmitter, and the data utilizer.

While only one utilizer terminal 14 is illustrated in FIG. 1, the information processing system 10 may include a plurality of utilizer terminals 14 used by a plurality of data utilizers. In addition, in a case where the data creator and the data transmitter are different persons, the information processing system 10 may include, instead of the manager terminal 12, a creator terminal that is used by the data creator, and a transmitter terminal that is used by the data transmitter.

The data that is created by the data creator, transmitted to the server 16 from the manager terminal 12 by the data transmitter, and managed by the server 16 has additional information. The additional information is information added to a data main body. The additional information includes note information and attribute information. The note information is information that is displayed on a display of a terminal used by the user together with a data content upon opening of the data by the user. For example, an annotation (text information) that is added to the data is used as the note information. The attribute information is meta information (properties) about the data and may be information that is not displayed upon opening of the data by the user. For example, information indicating a name of the data or the creator of the data is used as the attribute information. The additional information may be added to the data by the data creator or may be automatically attached by the manager terminal 12 (or the creator terminal) upon creation of the data by the data creator.

In the exemplary embodiment, the server 16 is a document management server that manages an electronic document as the data. Accordingly, the information processing system 10 is said to be a document management system. Since the data is the electronic document in the exemplary embodiment, hereinafter, the data creator will be referred to as a document creator, and the data transmitter will be referred to as a document transmitter. The data manager will be referred to as a document manager, and the data utilizer will be referred to as a document utilizer. The data managed by the server 16 is not limited to the electronic document. For example, the data may be image data or music data.

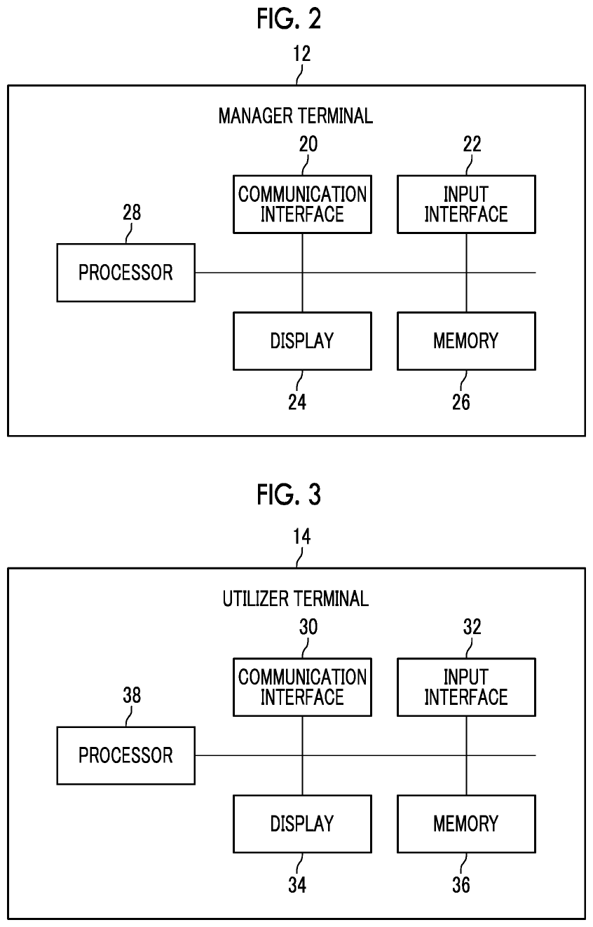

FIG. 2 is a schematic configuration diagram of the manager terminal 12. While the manager terminal 12 is a tablet terminal, for example, a personal computer or a smartphone, any computer may be used as the manager terminal 12 as long as functions described below are performed.

A communication interface 20 is configured to include, for example, a network adapter. The communication interface 20 performs a function of communicating with the server 16 through the communication line 18.

An input interface 22 is configured to include, for example, a touch panel, a button, a mouse, or a keyboard. The input interface 22 is used for inputting an instruction of the document manager into the manager terminal 12.

A display 24 is configured to include, for example, a liquid crystal panel. Various display screens are displayed on the display 24. Particularly, the electronic document provided from the server 16 is displayed on the display 24.

A memory 26 is configured to include, for example, a hard disk drive (HDD) , a solid state drive (SSD) , an embedded multi media card (eMMC) , a read only memory (ROM) , or a random access memory (RAM).

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device) . In the embodiments above, the term “processor” is broad enough to encompass one processor or plural processors in collaboration which are located physically apart from each other but may work cooperatively. The order of operations of the processor is not limited to one described in the embodiments above, and may be changed. The processor 28 controls each unit of the manager terminal 12.

FIG. 3 is a schematic configuration diagram of the utilizer terminal 14. A configuration of the utilizer terminal 14 is the same as the manager terminal 12. Thus, a communication interface 30, an input interface 32, a display 34, a memory 36, and a processor 38 will not be described.

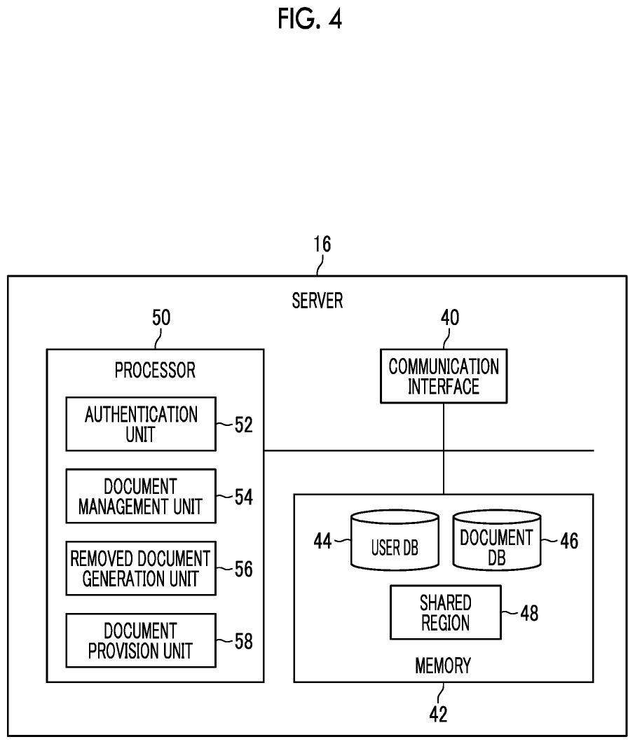

FIG. 4 is a schematic configuration diagram of the server 16. The server 16 is configured with, for example, a server computer. The server 16 may be configured with a plurality of computers. That is, functions performed by the server 16 described below may be implemented by cooperation among the plurality of computers.

A communication interface 40 is configured to include, for example, a network adapter. The communication interface 40 performs a function of communicating with the manager terminal 12 and the utilizer terminal 14 through the communication line 18.

A memory 42 is configured to include, for example, an HDD, an SSD, an eMMC, a ROM, or a RAM. The memory 42 stores an information processing program for functioning of each unit of the server 16. In addition, as illustrated in FIG. 4, a user database (DB) 44, a document DB 46, and a shared region 48 are defined in the memory 42.

In the user DB 44, a user ID for identifying a user who registers in advance on the server 16 (in other words, the document management service provided by the server 16), authentication information (for example, a password) for authenticating the user, a group (for example, a department, a team, or a project) to which the user belongs, a role (a job position, for example, a head of department or a project leader) of the user, and the like are stored in association with each other. Each information stored in the user DB 44 is input into the server 16 by the user in a case where the user registers on the server 16 or the document management service.

In the document DB 46, a document ID for identifying the electronic document transmitted from the document transmitter and a user ID of the document manager of the electronic document are stored in association with each other. In the exemplary embodiment, the document ID and user IDs of the document creator and the document transmitter are stored in association with each other. The document transmitter is authenticated by the server 16 (the document transmitter logs in to the server 16) in a case of transmitting the electronic document to the server 16. Thus, the server 16 can identify the document transmitter who transmits each electronic document. In addition, the server 16 can identify the document creator of each electronic document based on the attribute information about the electronic document. The user ID indicating the identified document transmitter or the document creator (that is, the document manager) is stored in the document DB 46 in association with a document ID of the electronic document.

The shared region 48 is a region that can be accessed by a plurality of users. A processor described later stores the electronic document transmitted from the document transmitter in the shared region 48. In a case where the electronic document is stored in the shared region 48, the plurality of users can access the electronic document. Accordingly, each user can download the electronic document to an own terminal and use the electronic document. The electronic document stored in the shared region 48 is said to be published to the plurality of users.

In addition, the shared region 48 may be a shared work region in which the plurality of users can execute a work related to the electronic document in cooperation with each other. In this case, the shared region 48 is a resource on the Internet, and the plurality of users can execute the work on the resource in cooperation with each other by accessing the resource.

A processor 50 refers to a processor in a broad sense and is configured to include at least one of a general-purpose processor (for example, a CPU) or a dedicated processing device (for example, a GPU, an ASIC, an FPGA, or a programmable logic device). The processor 50 may be configured by cooperation among a plurality of processing devices present at physically separated positions instead of one processing device.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device) . In the embodiments above, the term “processor” is broad enough to encompass one processor or plural processors in collaboration which are located physically apart from each other but may work cooperatively. The order of operations of the processor is not limited to one described in the embodiments above, and may be changed.

The processor 50 performs functions as an authentication unit 52, a document management unit 54, a removed document generation unit 56, and a document provision unit 58 in accordance with the information processing program stored in the memory 42.

The authentication unit 52 authenticates the user who accesses the server 16. Specifically, the authentication unit 52 requests the user to input the user ID and the authentication information and performs user authentication by collating the input user ID and the authentication information with reference to the user DB 44.

The document management unit 54 receives the electronic document from the user, particularly, the document transmitter, authenticated by the authentication unit 52. As described above, the additional information is added to the electronic document received by the document management unit 54 in the exemplary embodiment. Hereinafter, the electronic document that is received from the document transmitter and has the additional information will be referred to as an “original document” as original data. A plurality of pieces of additional information may be added to one original document. In the exemplary embodiment, the document management unit 54 receives the original document from the document transmitter by causing the document transmitter to transmit the original document to the server 16 from the manager terminal 12. However, the document transmitter may directly input the original document into the server 16.

The document management unit 54 stores the original document received from the document transmitter in the memory 42 and sets the original document to a state where the original document can be used by the plurality of users. In the exemplary embodiment, the document management unit 54 stores the original document in the shared region 48. In addition, the document management unit 54 stores the document ID of the original document, the user ID of the document transmitter who transmits the original document, and the user ID of the document creator of the original document obtained from the attribute information about the original document in the document DB 46 in association with each other.

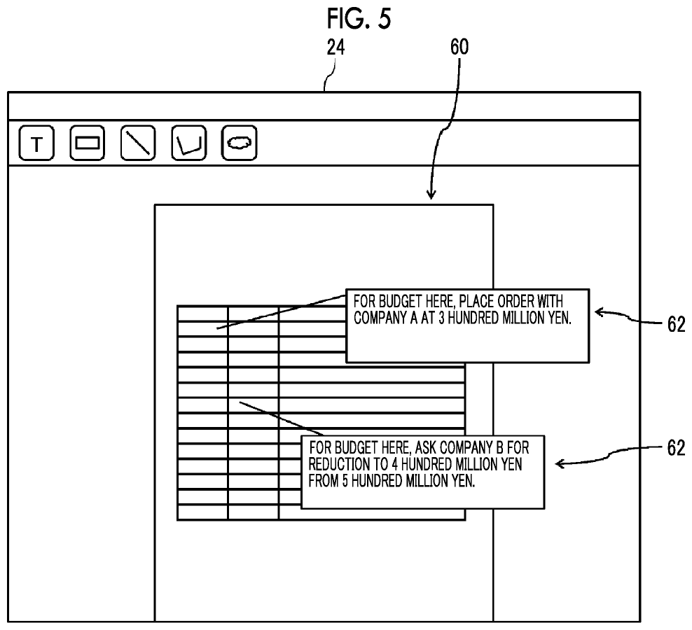

FIG. 5 is a diagram illustrating a display example of an original document 60 that has the additional information. The example in FIG. 5 is an example in which the original document 60 is displayed on the display 24 of the manager terminal 12. In the example in FIG. 5, two annotations 62 are added to the original document 60 as the additional information. Thus, the two annotations 62 are displayed together with a data main body of the original document 60. As described above, the additional information that is not displayed upon opening of the original document maybe added to the original document 60. Here, for example, in a case where confidential information or the like is included in the annotation 62, the annotation 62 is information that is not wanted to be viewed by the data utilizer.

In addition, the document management unit 54 can provide an application for editing the original document 60 to the document manager. The document manager can edit the original document 60 by executing the application on the manager terminal 12. A screen illustrated in FIG. 5 is an editing screen upon opening of the original document 60 by the application.

The removed document generation unit 56 generates an additional information-removed document as additional information-removed data in which the additional information is removed, based on the original document 60 stored in the memory 42 (in the exemplary embodiment, the shared region 48).

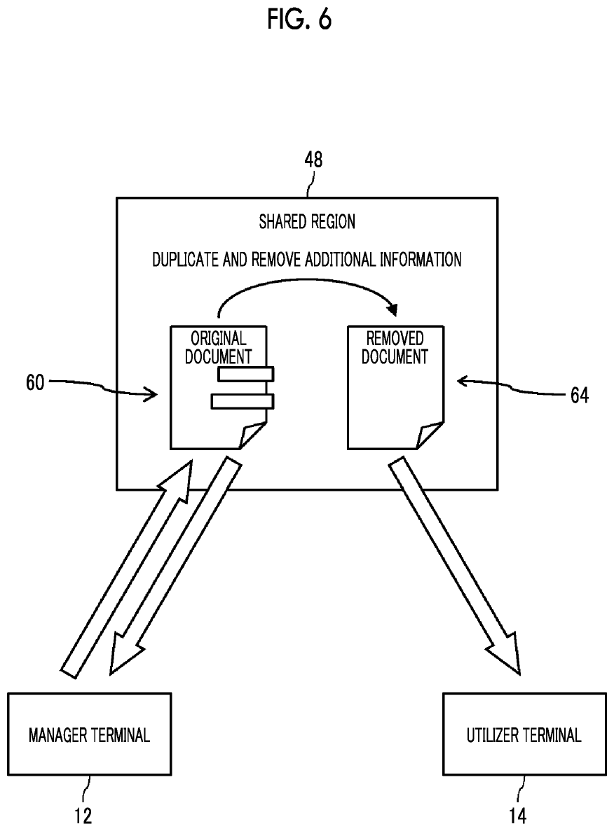

FIG. 6 is a conceptual diagram illustrating a processing content of the removed document generation unit 56 (and the document provision unit 58 described later). In the exemplary embodiment, the removed document generation unit 56 obtains a duplicated document as duplicated data by duplicating the original document 60 stored in the shared region 48 and generates a removed document 64 by removing the additional information from the duplicated document. According to this method, both of the original document 60 and the removed document 64 are stored in the shared region 48.

In addition, the removed document generation unit 56 may generate the removed document 64 by removing the additional information from the original document 60 stored in the shared region 48. In this method, after the removed document 64 is generated, the shared region 48 is in a state of not storing the original document 60 and storing the removed document 64. In this case, for example, the removed document generation unit 56 may store the removed document 64 and the removed additional information in the memory 42 in association with each other. By doing so, the document provision unit 58 described later can restore the original document 60 by adding (returning) the additional information to the removed document 64 based on the information stored in the memory 42, and provide the restored original document 60 to the document manager.

The removed document generation unit 56 can generate the removed document 64 at any timing after reception of the original document 60 from the document transmitter until provision of the original document 60 to the document utilizer. For example, in a case where a request for the original document 60 is made from the document utilizer, the removed document generation unit 56 can generate the removed document 64. Alternatively, the removed document generation unit 56 can generate the removed document 64 before the request for the original document 60 from the document utilizer. For example, the removed document generation unit 56 can generate the removed document 64 upon reception of the original document 60 from the document transmitter.

In a case where a request for the electronic document is made from the user authenticated by the authentication unit 52, the document provision unit 58 provides the electronic document related to the request to the user. While the document provision unit 58 provides the electronic document to the user by transmitting the electronic document to a terminal (the manager terminal 12 or the utilizer terminal 14) used by the user in the exemplary embodiment, the electronic document may be provided to the user by displaying the electronic document on a display (not illustrated) of the server 16 in a case where the user directly operates the server 16.

Particularly, in a case where the request for the original document 60 is made from the user, the document provision unit 58 refers to the document DB 46. In a case where the user is not the document manager of the original document 60, that is, in a case where the user is the document utilizer, the document provision unit 58, as illustrated in FIG. 6, provides the removed document 64 that is generated based on the original document 60 by the removed document generation unit 56 and in which the additional information is removed, to the document utilizer.

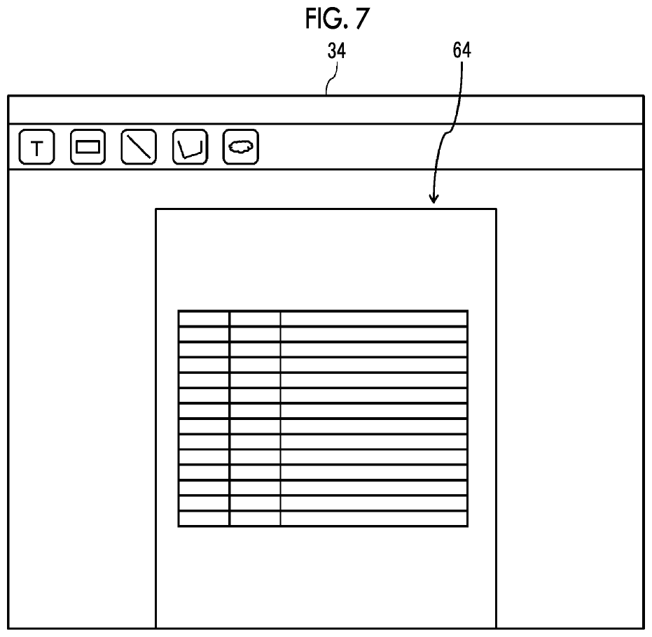

FIG. 7 is a diagram illustrating the removed document 64 displayed on the display 34 of the utilizer terminal 14. Since the removed document 64 does not have the additional information, apparently, a data main body of the removed document 64 is displayed on the display 34, and the additional information is not displayed. In addition, since the removed document 64 does not have not only the note information but also the attribute information, the attribute information is not displayed even in a case where the document utilizer tries to display properties of the removed document 64.

Meanwhile, in a case where the user is the document manager of the original document 60, the document provision unit 58 provides the original document 60 having the additional information to the document manager (that is, the manager terminal 12 used by the document manager). An example in which the original document 60 is displayed on the display 24 of the manager terminal 12 is illustrated in FIG. 5. The document provision unit 58 may provide the removed document 64 to the document manager in accordance with an instruction from the document manager. Accordingly, the document manager can check how the document utilizer requesting the original document 60 views the removed document 64.

Since the document provision unit 58 provides the removed document 64 in which the additional information is removed to the document utilizer, the document utilizer cannot view the additional information even in a case where the document manager wants the additional information to be viewed by the document utilizer. Particularly, in the exemplary embodiment, since the removed document 64 does not have the additional information, a possibility that the document utilizer views the additional information is reduced, compared to a case of providing the original document 60 having the additional information to the document utilizer and then, not displaying the additional information.

In the exemplary embodiment, the server 16 (particularly, the removed document generation unit 56) generates the removed document 64 based on the original document 60. Accordingly, the document manager may simply transmit the original document 60 to the server 16 and does not need to prepare and transmit the removed document 64 to the server 16. Accordingly, compared to a case where the document manager prepares and stores the original document 60 and the removed document 64 in the server 16, an effort of the document manager for not allowing the additional information added to the original document 60 to be viewed by the document utilizer is reduced while the document utilizer may use the removed document 64.

In a case where a plurality of pieces of additional information are added to the original document 60, publication setting information may be attached to at least one of the plurality of pieces of additional information. The publication setting information is information that indicates publication of the additional information to the document utilizer. In the exemplary embodiment, the publication setting information is attached by the document manager. The publication setting information may be attached by the manager terminal 12 or the document management unit 54. For example, the document management unit 54 may attach the publication setting information to the additional information in accordance with fields (for example, the annotation 62, a file name of the attribute information, and a file creator of the attribute information) of the additional information. In addition, the document management unit 54 may attach the publication setting information to the additional information in accordance with an analysis result of a text content of the annotation 62 (for example, a text string such as “publication allowed” is included).

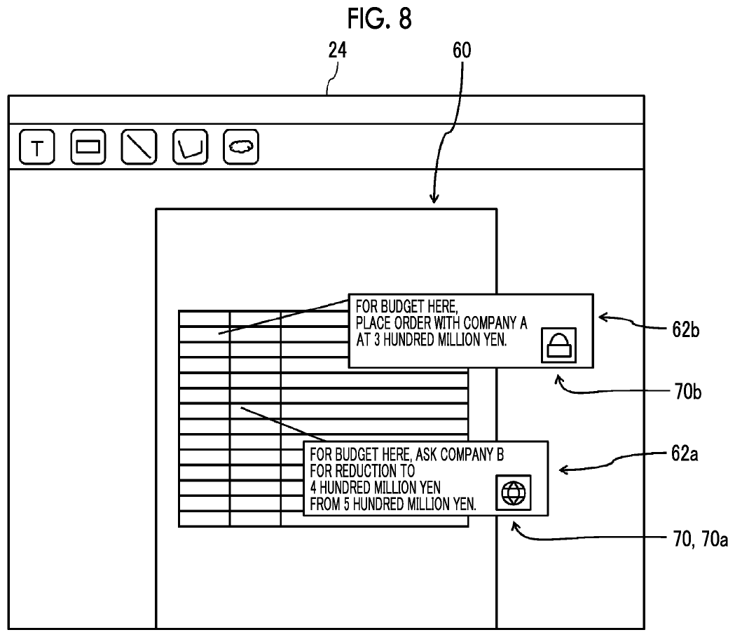

FIG. 8 is a diagram illustrating a first example of the editing screen of the original document 60 displayed on the display 24 of the manager terminal 12. As described above, the application for editing the original document 60 is provided from the document management unit 54. In the exemplary embodiment, a publication setting icon 70 is displayed on each annotation 62 attached to the original document 60 on the editing screen. In a case where the document manager operates (for example, clicks) the publication setting icon 70, attaching/not attaching the publication setting information to the annotation 62 can be switched. In addition, the publication setting icon 70 indicates whether or not the publication setting information is attached to the annotation 62. Specifically, different display aspects of the publication setting icon 70 are displayed on the annotation 62 to which the publication setting information is attached, and the annotation 62 to which the publication setting information is not attached. For example, as illustrated in FIG. 8, a publication setting icon 70a illustrating a publication mark is displayed on an annotation 62a to which the publication setting information is attached, and a publication setting icon 70b illustrating a non-publication mark is displayed on an annotation 62b to which the publication setting information is not attached.

In a case where the publication setting icon 70a is operated once from the state illustrated in FIG. 8, the publication setting icon 70a switches to the non-publication mark, and the publication setting information is removed from the annotation 62a. In addition, in a case where the publication setting icon 70b is operated once from the state illustrated in FIG. 8, the publication setting icon 70b switches to the publication mark, and the publication setting information is attached to the annotation 62b.

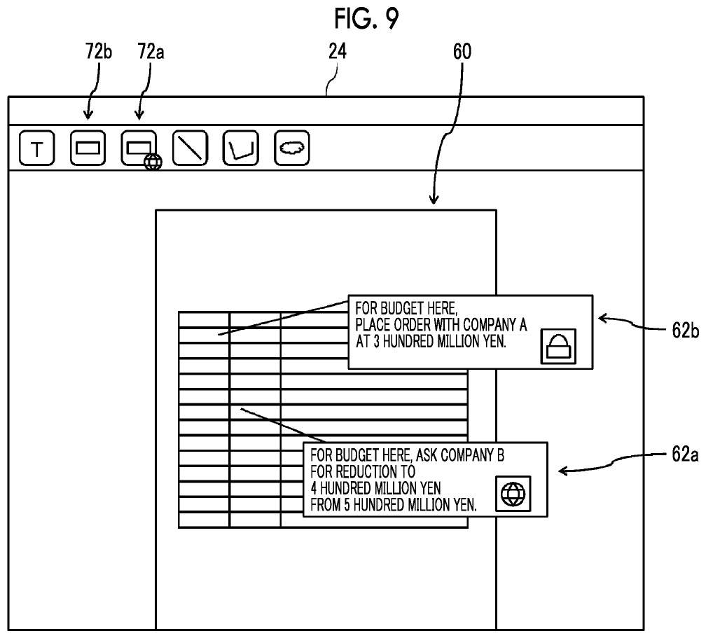

FIG. 9 is a diagram illustrating a second example of the editing screen of the original document 60. As illustrated in FIG. 9, the application for editing the original document 60 provided from the document management unit 54 may have a published additional information attachment button 72a as a first operator for attaching, to the original document 60, the additional information to which the publication setting information is attached, and a non-published additional information attachment button 72b as a second operator for attaching, to the original document 60, the additional information to which the publication setting information is not attached. Accordingly, the document manager can attach the additional information (for example, the annotation 62a) to which the publication setting information is attached, to the original document 60 by simply operating the published additional information attachment button 72a. That is, an effort of the document manager for attaching the publication setting information to the additional information is reduced.

In a case where the original document 60 has the additional information to which the publication setting information is attached, the removed document generation unit 56 generates the removed document 64 in which the additional information to which the publication setting information is attached is not removed, and in which the additional information to which the publication setting information is not attached is removed. Then, in a case where the request for the original document 60 is made from the document utilizer, the document provision unit 58 provides, to the document utilizer, the removed document 64 in which the additional information to which the publication setting information is attached is not removed, and in which the additional information to which the publication setting information is not attached is removed.

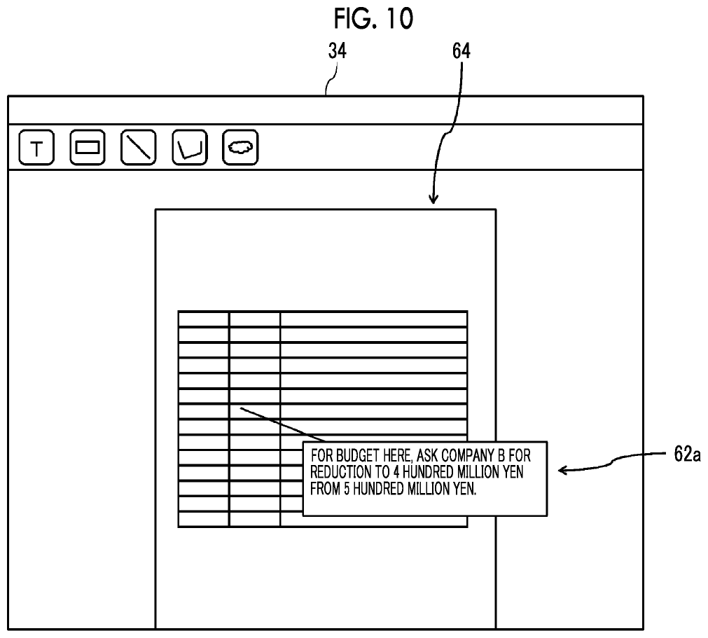

FIG. 10 is a diagram illustrating a display example of the removed document 64 on the display 34 of the utilizer terminal 14 in a case where the document utilizer requests the original document 60 having the additional information to which the publication setting information is attached as illustrated in FIG. 8. Since the publication setting information is attached to the annotation 62a attached to the original document 60, the annotation 62a is not removed in the removed document 64 generated by the removed document generation unit 56. Accordingly, the removed document 64 including the annotation 62a is displayed on the display 34, and the annotation 62a is published to the document utilizer (the document utilizer can view the annotation 62a).

By attaching the publication setting information to the additional information, the removed document 64 having a part of the pieces of additional information can be provided to the document utilizer in a case where the request for the original document 60 including the plurality of pieces of additional information is made from the document utilizer.

In a case where the plurality of pieces of additional information are added to the original document 60, the removed document 64 is a concept including a document in which a part of the pieces of additional information is removed (a part of the pieces of additional information is left). That is, the removed document 64 does not mean only a document in which all of the pieces of additional information of the original document 60 are removed.

In addition, in a case where the removed document generation unit 56 generates the removed document 64 in advance by removing the additional information from the duplicated document of the original document 60 before the request for the original document 60 from the document utilizer is received, each time the publication setting information is attached to the additional information of the original document 60 by editing the original document 60 by the document manager, the removed document generation unit 56 duplicates the original document 60 and generates again the removed document 64 in which the additional information to which the publication setting information is not attached is removed from the duplicated document (in other words, the removed document 64 in which the additional information to which the publication setting information is attached is left without removal) . Accordingly, even in a case where the request for the original document 60 is received from the document utilizer at anytime, the document manager can provide, to the document utilizer, the removed document 64 that has the additional information to which the publication setting information is attached, and in which the additional information to which the publication setting information is not attached is removed.

In addition, browsing-allowed person information that indicates the document utilizer who is allowed to browse the additional information may be attached to the additional information to which the publication setting information is attached. For example, the browsing-allowed person information may indicate the user ID of the document utilizer who is allowed to browse the additional information, a user group (for example, users belonging to a certain department) who is allowed to browse the additional information, or a role (for example, a head of department or a project leader of a certain project) who is allowed to browse the additional information.

In the exemplary embodiment, the browsing-allowed person information is attached by the document manager. A browsing-allowed person may also be attached by the document management unit 54. For example, the document management unit 54 may attach the browsing-allowed person information to the additional information in accordance with attributes of the document manager of the original document 60. For example, the document management unit 54 can attach the browsing-allowed person information indicating that the document utilizer who belongs to the same company as the document manager is allowed to browse, to the annotation 62. In addition, for example, the document management unit 54 may attach the browsing-allowed person information to the additional information in accordance with an analysis result of a text added to the original document 60 as the annotation 62 and the attributes of the document manager of the original document 60. For example, in a case where a text string such as “internal use only” is included in the annotation 62, the browsing-allowed person information indicating that the document utilizer belonging to the same company as the document manager is allowed to browse can be attached to the annotation 62.

In a case where the browsing-allowed person information is attached to the publication setting information, the removed document generation unit 56, upon the request for the original document 60 from the document utilizer, refers to the user DB 44 and generates the removed document 64 in which the additional information to which the browsing-allowed person information indicating that the document utilizer is allowed to browse is attached is not removed, and in which the additional information to which the browsing-allowed person information indicating that the document utilizer is not allowed to browse is attached is removed. The document provision unit 58 provides the removed document 64 to the document utilizer.

Accordingly, even the additional information to which the publication setting information is attached is not published to the document utilizer in a case where the browsing-allowed person information attached to the additional information indicates that the document utilizer requesting the original document 60 is not allowed to browse the additional information. That is, by attaching the browsing-allowed person information to the additional information, the original document 60 having a part of the additional information can be provided to an appropriate (indicated by the browsing-allowed person information) document utilizer in a case where the request for the original document 60 including the plurality of pieces of additional information is made from the document utilizer.

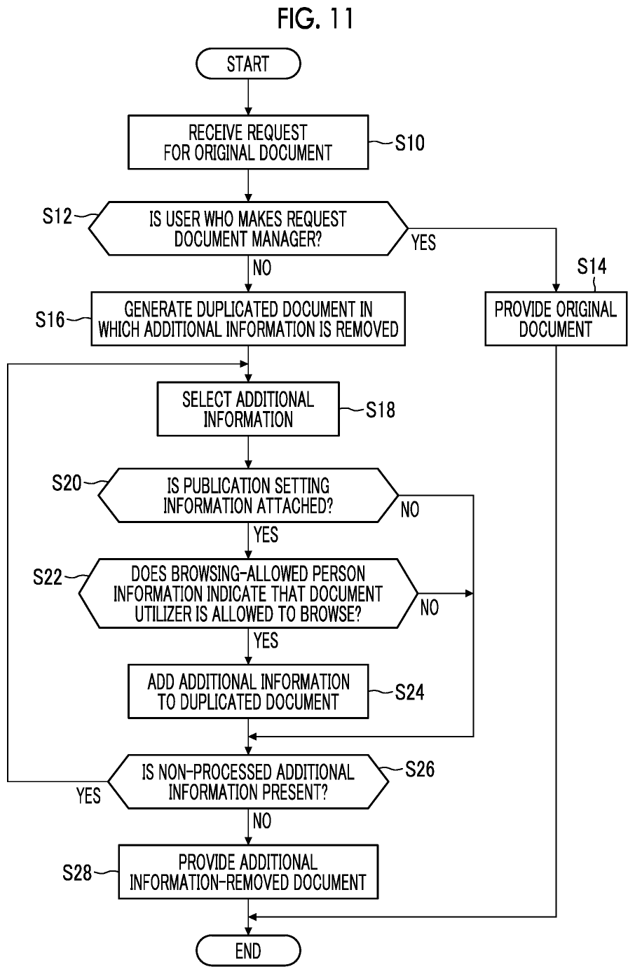

A summary of the server 16 according to the exemplary embodiment is described above. Hereinafter, a flow of processing of the server 16 will be described in accordance with the flowchart illustrated in FIG. 11. At a point in time of a start of the flowchart of FIG. 11, the original document 60 to which the plurality of pieces of additional information are added is transmitted to the server 16 by the document manager, and the original document 60 is stored in the shared region 48.

In step S10, the server 16 receives the request for the original document 60 from the authenticated user.

In step S12, the document provision unit 58 determines whether or not the user who requests the original document 60 from the server 16 in step S10 is the document manager, based on the user ID of the user authenticated in step S10 and the document DB 46.

IN a case where the user who requests the original document 60 is the document manager, a transition is made to step S14, and the document provision unit 58 provides the original document 60 having the additional information to the document manager and finishes the processing. In a case where the user who requests the original document 60 is not the document manager, that is, in a case where the user who transmits the request for the original document 60 is the document utilizer, a transition is made to step S16.

In step S16, the removed document generation unit 56 generates the duplicated document by duplicating the original document 60. Then, all pieces of additional information are temporarily deleted from the duplicated document.

In step S18, the removed document generation unit 56 selects one piece of additional information among the plurality of pieces of additional information of the original document 60.

In step S20, the removed document generation unit 56 determines whether or not the publication setting information is attached to the additional information selected in step S18. In a case where the publication setting information is not attached, a transition is made to step S26 by bypassing processing of steps S22 and S24. In a case where the publication setting information is attached, a transition is made to step S22.

In step S22, the removed document generation unit 56 determines whether or not the browsing-allowed person information attached to the additional information selected in step S18 indicates that the document utilizer who requests the original document 60 in step S10 is allowed to browse the additional information. In a case where the browsing-allowed person information indicates that the document utilizer is not allowed to browse the additional information, a transition is made to step S26 by bypassing processing of step S24. In a case where the browsing-allowed person information indicates that the document utilizer is allowed to browse the additional information, or in a case where the browsing-allowed person information is not attached to the additional information, a transition is made to step S24.

In step S24, the removed document generation unit 56 adds (returns) the additional information selected in step S18 to the duplicated document.

In step S26, the removed document generation unit 56 determines whether or not non-processed additional information that is the additional information of the original document 60 on which processing of steps S18 to S24 is not performed is present. In a case where the non-processed additional information is present, a return is made to step S18. In step S18 again, another additional information of the original document 60 is selected, and processing of steps S20 to S24 is repeated for the selected additional information. In a case where the non-processed additional information is not present, a transition is made to step S28.

In step S28, the document provision unit 58 provides the removed document 64 generated by the removed document generation unit 56 by processing of steps S16 to S24 to the document utilizer who requests the original document 60 in step S10.

While the exemplary embodiment according to the invention is described above, the invention is not limited to the exemplary embodiment and can be subjected to various modifications without departing from a gist of the invention.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
receive original data that is created by a data creator and has additional information, from a data transmitter; and
in a case where a request for the original data from a data utilizer who is a utilizer other than a data manager who is at least one of the data creator or the data transmitter is made, provide additional information-removed data that is obtained based on the original data and in which the additional information is removed, to the data utilizer.

2. The information processing apparatus according to claim 1, wherein the processor is configured to:
in a case where the request for the original data from the data utilizer is made, provide the additional information-removed data obtained by removing the additional information from duplicated data that is a duplicate of the original data, to the data utilizer.

3. The information processing apparatus according to claim 2, wherein the processor is configured to:
in a case where a request for the original data from the data manager is made, provide the original data having the additional information to the data manager.

4. The information processing apparatus according to claim 1,
wherein a plurality of pieces of additional information are added to the original data,
publication setting information that indicates publication of the additional information to the data utilizer is attached to at least one of the plurality of pieces of additional information, and
the processor is configured to:
in a case where the request for the original data from the data utilizer is made, provide the additional information-removed data in which the additional information to which the publication setting information is attached is not removed and in which the additional information to which the publication setting information is not attached is removed, to the data utilizer.

5. The information processing apparatus according to claim 4, wherein the processor is configured to:
provide an application having a first operator for adding the additional information to which the publication setting information is attached to the original data, and a second operator for adding the additional information to which the publication setting information is not attached to the original data, to the data manager.

6. The information processing apparatus according to claim 4, wherein the processor is configured to:
before the request for the original data from the data utilizer is received, generate the additional information-removed data by duplicating the original data and removing the additional information from duplicated data that is a duplicate of the original data; and
each time the publication setting information is attached to the additional information of the original data, duplicate the original data and generate again the additional information-removed data in which the additional information to which the publication setting information is not attached is removed, from the obtained duplicated data.

7. The information processing apparatus according to claim 4,
wherein browsing-allowed person information that indicates the data utilizer allowed to browse the additional information is attached to the additional information to which the publication setting information is attached, and
the processor is configured to:
in a case where the request for the original data from the data utilizer is made, provide the additional information-removed data in which the additional information to which the browsing-allowed person information indicating that the data utilizer is allowed to browse is attached is not removed and in which the additional information to which the browsing-allowed person information indicating that the data utilizer is not allowed to browse is attached is removed, to the data utilizer.

8. A non-transitory computer readable medium storing an information processing program causing a computer to execute a process comprising:
receiving original data that is created by a data creator and has additional information, from a data transmitter; and
providing additional information-removed data that is obtained based on the original data and in which the additional information is removed, to a data utilizer in a case where a request for the original data from the data utilizer who is a utilizer other than a data manager who is at least one of the data creator or the data transmitter is made.

9. An information processing apparatus comprising:
means for receiving original data that is created by a data creator and has additional information, from a data transmitter; and
means for providing additional information-removed data that is obtained based on the original data and in which the additional information is removed, to a data utilizer in a case where a request for the original data from the data utilizer who is a utilizer other than a data manager who is at least one of the data creator or the data transmitter is made.
